(19) United States
(12) Patent Application Publication
(10) Pub. No.: US 2023/0420985 A1
(43) Pub. Date: Dec. 28, 2023

(54) SYSTEMS AND METHODS FOR TESTING A DEVICE AS PER GRID INTERCONNECTION STANDARDS

(71) Applicant: BLOOM ENERGY CORPORATION, San Jose, CA (US)

(72) Inventors: Vishal Anand Aisur GOPALAKRISHNAN, San Jose, CA (US); Saravanakumar NARAYANASAMY, San Jose, CA (US); Badrinarayanan THIRUVENGADASAMY, San Jose, CA (US); Sreekanth VENKATESH, San Jose, CA (US); Vishal VARSHNEY, San Jose, CA (US); Anbarasu DORAI, San Jose, CA (US); Kodali Venkata Narasimha RAO, San Jose, CA (US)

(21) Appl. No.: 18/340,876

(22) Filed: Jun. 25, 2023

(30) Foreign Application Priority Data
Jun. 24, 2022 (IN) 202241036398

(51) Int. Cl. H02J 13/00

(52) U.S. Cl. CPC H02J 13/00002

(57) ABSTRACT

Embodiments of the present disclosure provide systems and methods for testing a device for grid interconnection standards. The method includes inputting a set of instructions to a device under test (DUT), where the instructions correspond to a firmware version to be tested by a variable AC source. The method includes transmitting a command signal to an inverter redundant controller (IRC) of the DUT, where the IRC operates at least one DC-AC inverter to attain a grid-tie state in response to receipt of the command signal. The method includes transmitting a set of values corresponding to parameters of the variable AC source configured to simulate an AC grid upon operating at least one DC-AC inverter in the grid-tie state. The method further includes accessing test output data of the DUT from measuring equipment and generating a test report based on responses of the DUT to a set of test waveforms.

### TECHNICAL FIELD

The present disclosure relates to grid interconnection and interoperability testing of a device and, more particularly relates, to systems and methods for testing the device as per various grid interconnection standards and generating test scripts thereof.

### BACKGROUND

Generally, the grid interconnection standards define requirements for interconnection and interoperability of distributed energy resources (DERs) with electric power systems (EPS) (e.g., public grid). Further, the grid interconnection standards implemented for a public grid may differ from country to country. In one example, the single-phase nominal voltage of the public grid as per grid standards in the United States is 120 volts (V), 60 Hertz (Hz), and in the United Kingdom, it is 230 V, 50 Hz. Further, the operating conditions, grid response in various operating conditions, and other parameters of the grid differ due to the grid standards associated with each geographic location.

As part of standard procedures, grid interconnection studies are performed to facilitate the testing of grid-connected equipment. The grid interconnection studies are performed using traditional methods (or manual processes) which include human intervention. Particularly, since different geographies have varied grid interconnection standards, a slew of tests are performed in a repetitive fashion, and reports are generated. However, these repetitive tests for testing the grid-connected equipment at different geographies are performed as manual processes that are time-consuming and laborious. Further, analysis of the test results by different interpersonal may lead to a dilution in the quality of the generated reports and may be error-prone.

Therefore, there is a need for efficient testing of devices that is required as a part of grid interconnection certification and automated generation of test reports, in addition to providing other technical advantages.

### SUMMARY

Various embodiments of the present disclosure provide methods and systems for testing a device as per various grid interconnection standards.

In an embodiment, a computer-implemented method performed by a central controller is disclosed. The method includes inputting a set of instructions to a device under test, where the set of instructions corresponds to a firmware version to be tested by a variable alternating current (AC) source. The variable AC source is electrically coupled to the device under test. Further, the method includes transmitting a command signal to an inverter redundant controller (IRC) of the device under test, where the IRC operates at least one direct current-to-alternating current (DC-AC) inverter, among a plurality of DC-AC inverters of the device under test, to attain a grid-tie state in response to receipt of the command signal. Furthermore, the method includes transmitting a set of values corresponding to parameters of the variable AC source configured to simulate an AC grid upon operating the at least one DC-AC inverter in the grid-tie state, where the set of values is derived based at least on grid interconnection standards. The set of values facilitates the generation of a set of test waveforms by the variable AC source. The method further includes accessing test output data of the device under test from measuring equipment. The test output data includes information related to the response of the device under test corresponding to each test waveform of the set of test waveforms. Thereafter, the method includes generating a test report based at least on the responses of the device under test to the set of test waveforms.

In another embodiment, a system for testing a device as per grid interconnection standards is disclosed. The device under test includes a plurality of direct current-to-alternating current (DC-AC) inverters and an inverter redundant controller (IRC). The system includes a variable AC source that is electrically coupled to the device under test. The variable AC source is configured to simulate an AC grid for performing the test based on the grid interconnection standards. Furthermore, the system includes measuring equipment coupled to the device under test and the variable AC source. The system further includes a central controller communicably coupled to the device under test, the variable AC source, and the measuring equipment. The central controller is configured to input a set of instructions to the device under test, where the set of instructions corresponds to a firmware version is to be tested by the variable AC source. Further, the central controller is configured to transmit a command signal to the IRC, where the IRC is operating at least one DC-AC inverter, among the plurality of DC-AC inverters, to attain a grid-tie state in response to receipt of the command signal. Furthermore, the central controller is configured to transmit a set of values corresponding to parameters of the variable AC source upon operation of the at least one DC-AC inverter in the grid-tie state, the set of values derived based at least on grid interconnection standards. The set of values facilitates the generation of a set of test waveforms by the variable AC source. Thereafter, the central controller is configured to access test output data of the device under test from the measuring equipment, the test output data including information related to the response of the device under test corresponding to each test waveform of the set of test waveforms. The central controller is further configured to generate a test report based at least on the responses of the device under test to the set of test waveforms.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale.

FIG. 1 is an illustration of a system for testing a device as per various grid interconnection standards, in accordance with an embodiment of the present disclosure;

FIG. 2 is a simplified block diagram representation of a central controller, in accordance with an embodiment of the present disclosure;

FIG. 3 depicts a test signal as defined in grid interconnection standard IEEE 1547-2018;

FIG. 4A depicts a table including values for parameters of a variable AC source derived for an over-voltage test, in accordance with an embodiment of the present disclosure;

FIG. 4B depicts a table including values to be sent to the variable AC source for the over-voltage test, in accordance with an embodiment of the present disclosure;

FIG. 5A depicts a table including values for parameters of a variable AC source derived for an over-frequency test, in accordance with an embodiment of the present disclosure;

FIG. 5B depicts a table including values to be sent to the variable AC source for the over-frequency test, in accordance with an embodiment of the present disclosure; and

FIG. 6 represents a flow diagram of a method performed at a central controller for testing a device under test, in accordance with an embodiment of the present disclosure

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or conjunction with each other, one skilled in the art will appreciate that many of these features can be provided independently of other features. Accordingly, this description of the present disclosure is set forth without any loss of generality, and without imposing limitations upon, the present disclosure.

### Overview

Various examples of the present disclosure provide methods and systems for testing a device as a part of grid interconnection certification. The device is tested to check whether the device meets the requirements of various grid interconnection standards. The grid interconnection standards vary from region to region, therefore, a slew of tests needs to be performed in a repetitive fashion and reports need to be generated. A method is provided to perform the slew of tests on the device without human intervention and to automate the generation of test reports. The device under test (DUT) includes a plurality of direct current-to-alternating current (DC-AC) inverters and an inverter redundant controller (IRC) in an example.

The overall system includes a variable alternating-current (AC) source, measuring equipment, a load, a distributed energy resource (DER), a direct-current (DC) source, and a central controller. The central controller implements the method to be performed for executing the test of DUT. Initially, the DUT is installed with a firmware version that needs to be tested for various conditions of a grid simulated by the variable AC source. The variable AC source receives instructions from the central controller to simulate waveforms that occur in the grid. The DUT receives commands from the central controller to switch a DC-AC inverter of the DUT to a grid-tie state. In the grid-tie state, the DC-AC inverter converts DC voltage from the DC source and provides AC voltage to the grid/variable AC source upon connection with the grid/variable AC source. Upon the occurrence of disruptive changes in parameters of the grid/variable AC source, the DUT ceases to provide AC voltage to the grid and the response of the DUT is captured by the measuring equipment. The central controller obtains responses from the measuring equipment and generates a report including multiple responses of the DUT to varied types of parameter changes that occurred at the grid (i.e., test waveforms simulated by the variable AC source). Several tests are performed to check the performance of the DUT under various parameter changes occurring in the grid. The tests include an over-voltage test, an under-frequency test, etc.

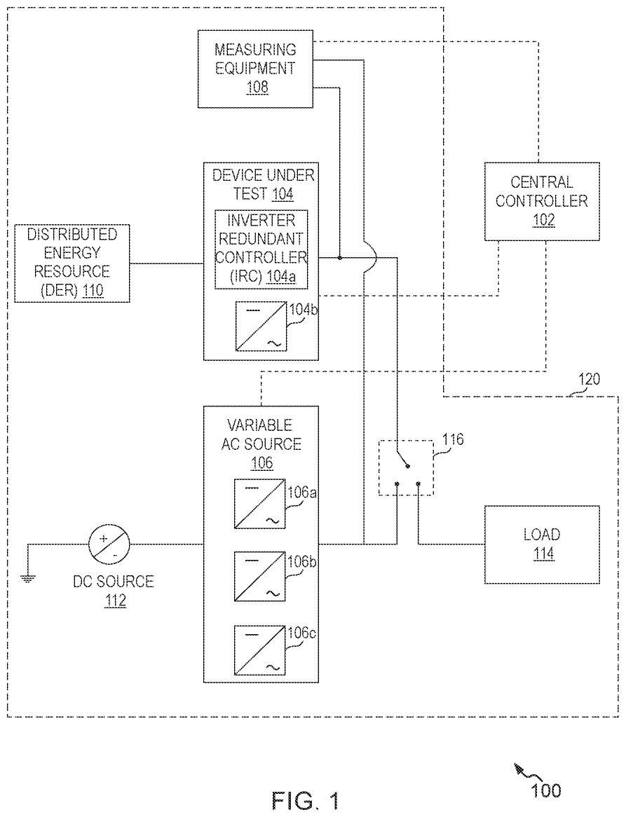

Various example embodiments of the present disclosure are described hereinafter with reference to FIGS. 1-6.

FIG. 1 is a block diagram representation of a system 100 for testing a device as per various grid interconnection standards, in accordance with an embodiment of the present disclosure. As shown, the system 100 includes one or more operating components which are interconnected to facilitate automation of various test protocols as per grid interconnection standards of different geographic locations. The system 100 includes a central controller 102 for testing a DUT 104, a variable alternating current (AC) source 106, a measuring equipment 108, a distributed energy resource (DER) 110, a direct current (DC) source 112, a load 114, and a switch 116. The central controller 102, DUT 104, variable AC source 106, measuring equipment 108, DER 110, DC source 112, load 114, and switch 116 are part of a circuit 120. The central controller 102 is configured to monitor and control the elements of the circuit 120. The circuit 120 is where a test is carried out and the central controller 102 executes a method to test the DUT 104. The test includes verification of the working of the DUT 104 as per grid interconnection standards (e.g., IEEE 1547-2018, IEEE 1547.1-2020, and VDE-AR-N 4110) under multiple conditions simulated by the variable AC source 106. The test may be under-voltage, over-voltage, under-frequency, over-frequency, reverse or minimum import power tests, etc.

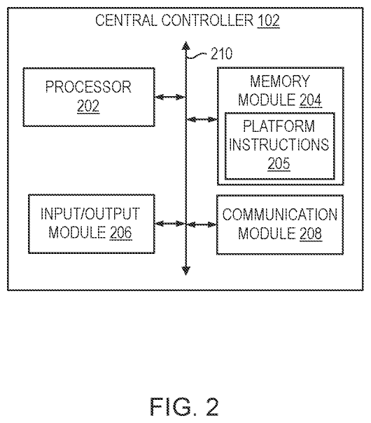

The central controller 102 is configured to control the DUT 104, the variable AC source 106, and the measuring equipment 108 for performing the test. The central controller 102 is connected to the elements of the circuit 120 through a wired or a wireless network. The structural configuration and functions of the central controller 102 are explained in detail with reference to FIG. 2.

The DUT 104 is the device that is to be tested by the central controller 102. The DUT 104 includes an inverter redundant controller (IRC) 104a and a DC-AC inverter 104b. In the illustrated configuration, a single DC-AC inverter 104b is shown for exemplary purposes and there can be more than one DC-AC inverter 104b in the DUT 104. The DC-AC inverter 104b converts DC power from the distributed energy resource (DER) 110 to AC power and provides the AC power to the variable AC source 106 upon connection with the variable AC source 106. The DER 110 can be at least one of a solid oxide fuel cell (SOFC) system, a solar power system, or a wind power system. For example, the DUT 104 may be a DC-AC inverter 104b connected to a SOFC system to convert the DC power from the SOFC system to AC power and provide the AC power to a grid. In the illustrated example embodiment, the grid is simulated by the variable AC source 106 for testing the DUT 104.

In general, for the interconnection of the DUT 104 with the grid and to provide the AC power to the grid, the DUT 104 has to meet the technical specifications of various grid interconnection standards, such as IEEE 1547-2018, 1547.1-2020, and VDE-AR-N 4110. The IEEE standard 1547-2018 defines technical specifications for, and testing of, interconnection, and interoperability of DERs with associated electric power systems (EPS) interfaces. The IEEE 1547.1-2020 defines the tests and evaluations that shall be performed to confirm that the interconnection and interoperation functions of the DUT 104 interconnecting DERs 110 with electrical power systems (EPS) (such as grid, microgrid, etc.) conform to the IEEE Std. 1547.

The DUT 104 is configured to receive a set of instructions from the central controller 102. The set of instructions corresponds to a firmware version to be installed on the DUT 104. In other words, the set of instructions includes operations that the DUT 104 has to perform when subjected to different operating conditions of the variable AC source 106. For example, the DUT 104 is configured to cease energizing a grid when the grid malfunctions and the DUT 104 is already connected to the grid. The set of instructions may further include values of parameters (such as trip time and trip voltage) to be adhered to by the DUT 104 while performing the operations. The trip voltage is a voltage of grid/variable AC source 106 at which the DUT 104 is configured to cease energizing the grid/variable AC source 106. The trip time is the time period in which the DUT 104 has to cease energizing upon the detection of the trip voltage. For example, the DUT 104 may be configured to cease energizing the grid (i.e., providing AC power to the variable AC source 106) when the voltage of the grid is 576V. In this case, the trip voltage of the DUT 104 was set to 580V. The values of the parameters for the DUT 104 are determined by the central controller 102 based on the various grid interconnection standards. The values of the parameters can be different for different grid interconnections standards. For example, the trip voltage of the DUT 104 for the US can be defined as 580V and the trip voltage of the DUT 104 for India can be defined as 500V, and the DUT 104 has to cease energizing the grid when the grid voltage is greater than or equal to 580V for the US. In this case, the firmware version of the DUT 104 is tested to check whether the DUT 104 operates as required by the various grid interconnection standards. The determination of the set of instructions (i.e., firmware version) to be installed on the DUT 104 by the central controller 102 will be explained later in reference to FIG. 2.

Further, the DUT 104 is configured to receive a command signal upon installation of the firmware version from the central controller 102, when the DUT 104 is operated in an active mode. The command signal indicates the IRC 104a of the DUT 104 to transition at least one DC-AC inverter 104b of the DUT 104 to a grid-tie state. The grid-tie state is a state in which a DC-AC inverter processes the DC power from the DER 110, converts the DC power to AC power, and provides the AC power to the variable AC source 106.

The variable AC source 106 is a controlled, yet variable, voltage solution. The variable AC source 106 is commonly used in conjunction with a controller (e.g., the central controller 102) to simulate multiple test waveforms with varying voltages and frequencies. The variable AC source 106 is electrically connected to a DC source 112 to power the variable AC source 106. The variable AC source 106 includes one or more DC-AC inverters 106a, 106b, and 106c to convert DC voltage from the DC source 112 to AC voltage. The variable AC source 106 may further include a communication module (not shown in FIG. 1) to receive instructions from the central controller 102 via a network (not shown in FIG. 1). The instructions may include values of multiple parameters responsible for operating the one or more DC-AC inverters 106a-106c of the variable AC source 106 to simulate the multiple test waveforms as defined in grid interconnection standards such as IEEE 1547. The variable AC source 106 may receive the instructions from the central controller 102 after a DC-AC inverter 104b of the DUT 104 is switched ON and is transitioned into a grid-tie state. The variable AC source 106 simulates the multiple test waveforms to test the operation of the DUT 104. The variable AC source 106 is configured to simulate conditions that occur in a real-time grid such as a public grid or a microgrid or any network for transfer of power. The instructions received by the variable AC source 106 are generated by the central controller 102, which will be explained later in reference to FIG. 2. Further, the variable AC source 106 is further configured to generate a pulse signal to mark instances at which the variable AC source 106 receives the instructions from the central controller 102. For example, the variable AC source 106 generates a pulse signal to mark the time instances at which the variable AC source 106 changes the voltage of a test waveform. Further, the pulse signal can be a digital input signal toggled to mark time instances whenever instructions are received from the central controller 102 to simulate a test waveform with certain values. Thereafter, the variable AC source 106 may send the pulse signal to the measuring equipment 108 for marking time instances. In one example embodiment, the variable AC source 106 is a four-quadrant AC source. The four-quadrant AC source is configured to operate instantaneously based on the set of values of the parameters received from the central controller 102.

The measuring equipment 108 is a means to measure the electrical outputs from the DUT 104 and the variable AC source 106. The measuring equipment 108 is a precision power scope or a power analyzer to perform multi-phase power measurements. The measuring equipment 108 is configured to monitor the outputs of the DUT 104 and the variable AC source 106, and capture the response of the DUT 104 to respective changes in the test waveforms simulated by the variable AC source 106. The measuring equipment 108 is configured to receive a pulse signal from the variable AC source 106. The measuring equipment 108 is configured to mark one or more time instances from the responses of the DUT 104 based on the pulse signal. The pulse signal indicates the changes in operating conditions of the variable AC source 106.

The load 114 is an electrical load that consumes AC power. The load 114 is connected to the DUT 104 and the variable AC source 106 through a switch 116. The switch 116 is configured to operate in a closed state between the DUT 104 and the variable AC source 106 when parameters determining the operating condition of the variable AC source 106 are within a threshold value defined for each of the parameters as per the grid interconnection standards. The parameters determining the operating condition of the variable AC source 106 include voltage, frequency, and phase of a test waveform generated by the variable AC source 106. The switch 116 facilitates transmission of the AC power provided by the DUT 104 to the variable AC source 106 when the switch 116 is operated in the closed state. The switch 116 is configured to operate in an open state when the parameters of the variable AC source exceed the threshold value defined for each of the one or more parameters. The switch 116 facilitates the disconnection of the DUT 104 from the variable AC source 106 when the switch is operated in the open state. Thereafter, the switch 116 facilitates a connection between the DUT 104 and the load 114 when the switch 116 is operated in the closed state between the DUT 104 and the load 114.

FIG. 2 is a block diagram of a central controller 102 which is configured to control one or more components in the circuit 120, in accordance with an embodiment of the invention.

The central controller 102 is depicted to include a processor 202, a memory module 204, an input/output (I/O) module 206, and a communication module 208. It is noted that although the central controller 102 is depicted to include the processor 202, the memory module 204, the I/O module 206, and the communication module 208, in some embodiments, the central controller 102 may include more or fewer components than those depicted herein. The various components of the central controller 102 may be implemented using hardware, software, firmware, or any combination thereof.

In one embodiment, the processor 202 may be embodied as a multi-core processor, a single-core processor, or a combination of one or more multi-core processors and one or more single-core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application-specific integrated circuit (ASIC), a graphic processing unit (GPU), a field-programmable gate array (FPGA), a microcontroller unit (MCU), a hardware accelerator, a special-purpose computer chip, or the like. In one embodiment, the memory module 204 is capable of storing machine-executable instructions, referred to herein as platform instructions 205. Further, the processor 202 is capable of executing the platform instructions 205. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory module 204 may be embodied as one or more non-volatile memory devices, one or more volatile memory devices, and/or a combination of one or more volatile memory devices and non-volatile memory devices. For example, the memory module 204 may be embodied as semiconductor memories, such as flash memory, mask ROM, PROM (programmable ROM), EPROM (erasable PROM), RAM (random access memory), etc. and the like.

The communication module 208 is configured to facilitate communication between the central controller 102 and one or more components in the system 100 using a wired network, a wireless network, or a combination of wired and wireless networks. Some non-limiting examples of wired networks may include the Ethernet, the Local Area Network (LAN), a fiber-optic network, and the like. Some non-limiting examples of wireless networks may include the Wireless LAN (WLAN), cellular networks, Bluetooth or ZigBee networks, and the like.

The various components of the central controller 102, such as the processor 202, the memory module 204, the I/O module 206, and the communication module 208 are configured to communicate with each other via or through a centralized circuit system 210. The centralized circuit system 210 may be various devices configured to, among other things, provide or enable communication between the components of the central controller 102. In certain embodiments, the centralized circuit system 210 may be a central printed circuit board (PCB) such as a motherboard, a mainboard, a system board, or a logic board. The centralized circuit system 210 may also, or include other printed circuit assemblies (PCAs) or communication channel media.

In an example embodiment, the communication module 208 is configured to send a set of instructions to the DUT 104. The set of instructions corresponds to a firmware version that has to be installed on the DUT 104. The firmware version is tested upon the installation with a test by the central controller 102. Further, the set of instructions includes operations that the DUT 104 has to perform when subjected to different operating conditions of the variable AC source 106. For example, the DUT 104 is configured to cease energizing a grid when the grid malfunctions, whereas the DUT 104 is connected to the grid. For the purposes of testing, the grid is simulated by a variable AC source 106. The set of instructions may further include values of the parameters (such as trip time and trip voltage) for the functioning of the DUT 104. The values of the parameters are those values that the DUT 104 has to adhere to while performing the operations. The trip voltage defines the voltage of the variable AC source 106 at which the DUT 104 may cease to energize and the trip time defines the time period in which the DUT 104 has to complete the cease operation after detecting the trip voltage at the variable AC source 106. For example, the DUT 104 may be configured to cease energizing the grid when the voltage of the grid is 580V, indicating that the value of trip voltage sent to the DUT 104 is 580V with some tolerance.

Before sending the set of instructions, the processor 202 is configured to determine the values of the parameters based on various grid interconnection standards. The values of the parameters can be different for different grid interconnections standards. For example, the trip voltage for the US can be determined as 576V and the trip voltage for India can be determined as 500V based on respective grid interconnection standards, and the DUT 104 has to cease energizing the grid when the DUT 104 detects that the grid voltage is greater than or equal to 576V for the US. Upon installation of the firmware version, the DUT 104 is set to be tested by the central controller 102 to check whether the DUT 104 meets the requirements defined by the grid interconnection standards.

The communication module 208 is configured to transmit a command signal to an inverter redundant controller (IRC) of the DUT 104. The command signal indicates the IRC to shift a state of the DC-AC inverter of the DUT 104 to a grid-tie state. The grid-tie state indicates a state of operation of the DUT 104 in which the DUT 104 can process direct-current voltage from a DC source and convert the DC voltage into alternating-current (AC) voltage to be provided to a grid. The communication module 208 is configured to transmit the command signal to the IRC upon determining that the DUT 104 is operated in an active mode. The active mode is a mode in which the DC-AC inverter of the DUT 104 is switched ON. For example, the communication module 208 sends a command signal to shift the DC-AC inverter to a grid-tie state when the DC-AC inverter is switched ON (i.e., when the DER 110 is connected to the DC-AC inverter).

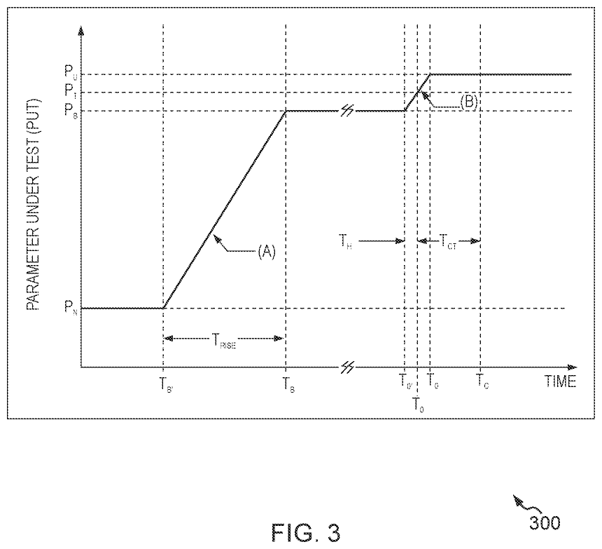

The processor 202 is configured to derive a set of values of parameters of the variable AC source based on a test signal defined in a grid interconnection standard. For example, the test signal 300 defined in IEEE 1547-2018 is depicted in FIG. 3. The test signal provides a waveform of a parameter under test. The parameter under test can be one of voltage, frequency, power, reactive power, etc. The test signal is defined by the set of expressions given below:

For time t_{b′} to t_{b}: P(t)=A×u(t_{b}−t_{b′})+P_{N} (1)

For time t_{b} to t_{0′}: P(t)=P_{B} (2)

For time t_{0′} to t_{0″}: P(t)=B×v(t_{0′}−t_{0″})+P_{B} (3)

For time t_{0″} to more than t_{ct}: P(t)=P_{U} (4)
where
   P is the magnitude of parameter under test (PUT) (V, f, P, Q, etc.);
   t is time (s);
   A, B are scaling factors; and
   u(t), v(t) are the unit step functions

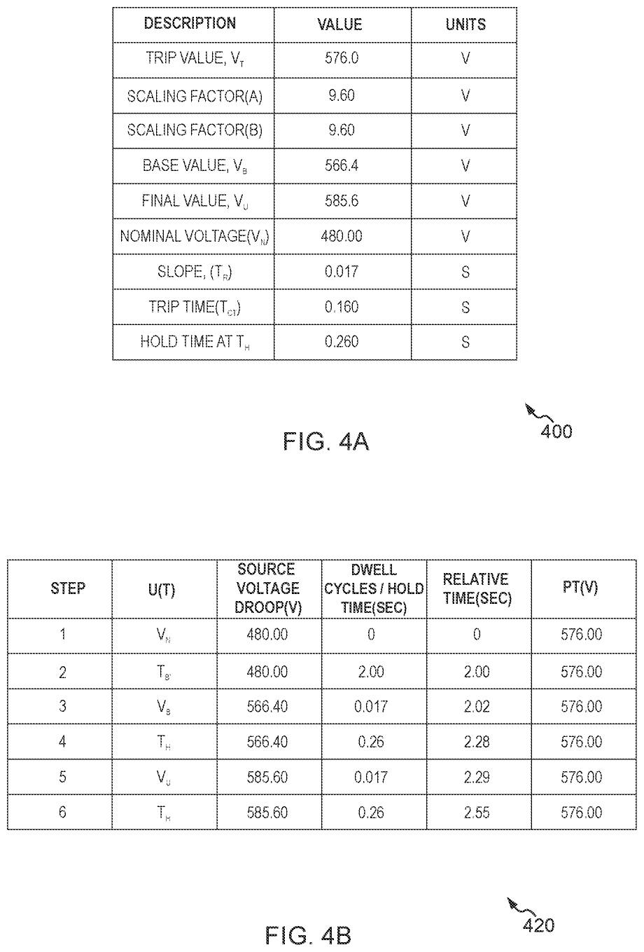

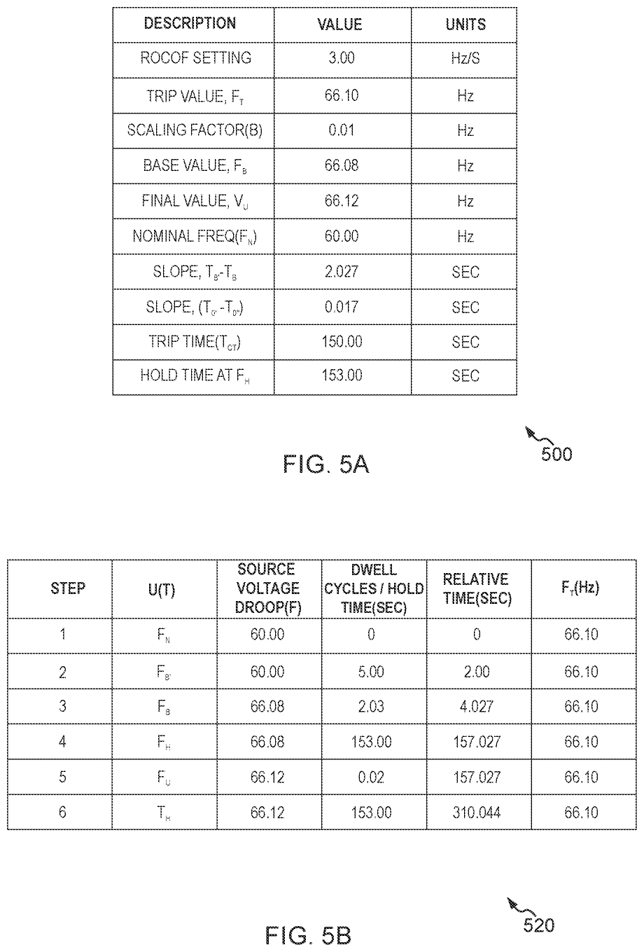

The processor 202 is further configured to determine the set of values of parameters of the variable AC source 106 based on at least the grid interconnection standard and a type of test to be performed. The set of values of parameters of the variable AC source 106 is used to simulate a test waveform with the set of values for the test. The test may include one of under-voltage, over-voltage, under-frequency, over-frequency, reverse or minimum import power tests, etc. The parameters of the variable AC source 106 may include Trip Value (V_{T}), Scaling factor (A), Scaling factor (B), Base Value (V_{B}), Final Value (V_{U}), Nominal voltage(V_{N}), Slope (Tᵣ), Trip Time (T_{Ct}), and Hold time (TH). For example, the set of values of the parameters of the variable AC source 106 determined for an over-voltage test is shown in table 400 of FIG. 4A. The parameter under test (PUT) in the over-voltage test is voltage. In another example, the set of values of the parameters of the variable AC source 106 determined for an over-frequency test is shown in table 500 of FIG. 5A. The PUT in the over-frequency test is frequency.

Upon determining that the DUT 104 is in a grid-tie state, the communication module 208 is configured to transmit a set of values to the variable AC source 106 to simulate the set of test waveforms similar to the test signal shown in FIG. 3 with the set of values. In one example, the set of values used for simulation of the test waveform for the over-voltage test is shown in table 420 of FIG. 4B. In another example, the set of values used for simulation of the test waveform for the over-frequency test is shown in table 520 of FIG. 5B.

The communication module 208 is configured to access test output data from the measuring equipment 108. The test output data is captured by the measuring equipment 108 and the test output data indicates the responses of the DUT 104 to the multiple test waveforms of the variable AC source 106. In one example embodiment, the test output data includes information related to a response of the DUT 104 corresponding to each test waveform of the set of waveforms.

The processor 202 is configured to generate a test report based at least on the response of the DUT 104 to the set of test waveforms. The generation of the test report includes extracting one or more variables determining the responses of the DUT 104 to each test waveform from the test output data, and thereafter, generating the test report by analyzing the one or more variables determining the response to the DUT 104 to each test waveform of the set of waveforms. The one or more variables may include voltage, frequency, and time measurement at the output of the DUT 104.

In one example embodiment, prior to the access of the test output data, the processor 202 is configured to monitor each test waveform of a set of test waveforms being simulated by the variable AC source 106 to detect a change in magnitude of an electrical parameter of the test waveform at one or more time instances. Further, the processor 202 is configured to facilitate the transmission of a pulse signal from the variable AC source 106 to the measuring equipment 108 based on detecting the change in magnitude of the electrical parameters at the one or more test instances. The pulse signal facilitates the measuring equipment 108 to mark the one or more time instances in the test output data. The processor 202 is configured to determine the response of the DUT 104 at the one or more time instances based on the mark indicated for each of the one or more time instances in the test output data and the one or more variables at each mark. For example, the pulse signal is used to indicate the time instance at which trip voltage was simulated by the variable AC source 106 and mark the response of the DUT 104 at the trip voltage.

Further, the processor 202 is configured to monitor one or more parameters determining the operating condition of the variable AC source 106. The one or more parameters include amplitude, frequency, and phase of a test waveform generated by the variable AC source 106. The processor 202 is further configured to operate a switch (i.e., the switch 116) based on a comparison between one or more parameters and a threshold value defined in the grid interconnection standards. For example, the switch 116 will be operated in a closed state between the DUT 104 and the variable AC source 106 when the one or more parameters of the variable AC source 106 are within the threshold value.

The objective of the test performed by the central controller 102 is to check whether the DUT 104 or the firmware version of the DUT 104 is operating as per the grid interconnection standards. In other words, checking the operation of the DUT 104 under various conditions (i.e., trip voltage) occurring in a grid and verifying whether the DUT 104 ceases to energize the faulty grid within the trip time.

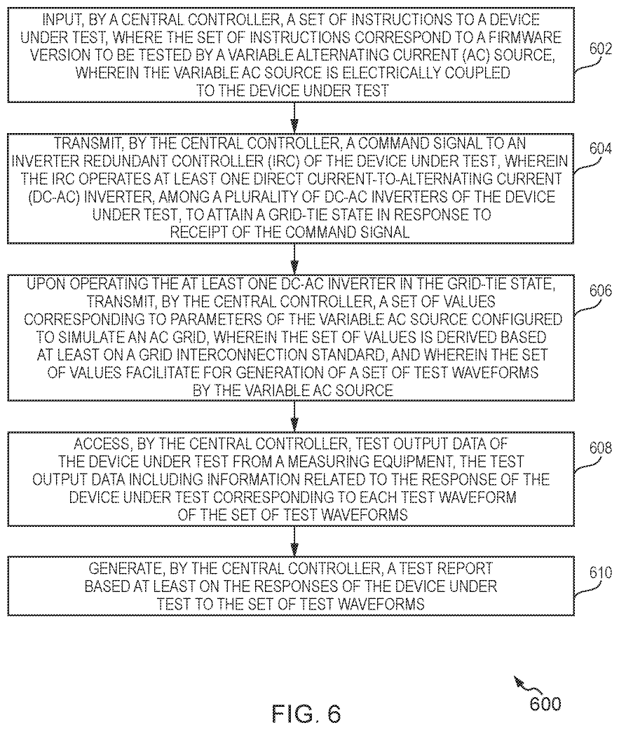

FIG. 6 represents a flow diagram depicting a method 600 for automating a test protocol, in accordance with example embodiments of the present disclosure. The method 600 depicted in the flow diagram may be executed by a central controller (e.g., the central controller 102). Operations of the method 600 and combinations of operations in the flow diagram, may be implemented by, for example, hardware, firmware, a processor, circuitry, and/or a different device associated with the execution of software that includes one or more computed program instructions. The method 600 starts at operation 602.

At operation 602, the central controller inputs a set of instructions (i.e., firmware version) in a device under test (DUT). The set of instructions corresponds to a firmware version to be installed on the DUT. The firmware version is tested upon the installation with a test by the central controller. Further, the set of instructions includes operations that the DUT has to perform when subjected to different operating conditions of the variable AC source. The variable AC source is configured to simulate an AC grid. The variable AC source is electrically coupled to the DUT via a switch.

At operation 604, the central controller transmits a command signal to the DUT. For example, the command signal is transmitted to an inverter redundant controller (IRC) of the DUT. Further, the command signal indicates the IRC of the DUT to transition the DC-AC inverter to a grid-tie state. The grid-tie state is a state in which a DC-AC inverter processes DC power from a DC source, converts the DC power to AC power, and provides the AC power to the variable AC source.

At operation 606, the central controller transmits a set of values corresponding to parameters of a variable AC source to simulate an AC grid upon operating the at least one DC-AC inverter in the grid-tie state. The set of values is derived based at least on grid interconnection standards such as IEEE 1547.1-2020. The set of values facilitates for generation of a set of waveforms by the variable AC source. The parameters for the variable AC source may include voltages, frequencies, and dwell times to program the variable AC source in order to verify the proper operation of the firmware version of the DUT.

At operation 608, the central controller accesses test output data from measuring equipment, where the test output data is related to a response of the DUT to a test waveform of the variable AC source. The test data may include information related to voltage at the output of the DUT in response to a test waveform simulated by the variable AC source. The test output data may be utilized to determine the voltage of the variable AC source at which the DUT ceased to energize the variable AC source.

At operation 610, the central controller is configured to generate a test report based at least on the responses of the DUT to the set of waveforms. The test report is generated by analyzing the test data to determine the values required by the grid interconnection standard.

The disclosed method with reference to FIG. 6, or one or more operations of flow diagram 600 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components)) and executed on a computer (e.g., any suitable computer, such as a laptop computer, netbook, Webbook, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means include, for example, the Internet, the World Wide Web, an intranet, software applications, cable (including fiber optic cable), magnetic communications, electromagnetic communications (including RF, microwave, and infrared communications), mobile communications, or other such communication means.

Various embodiments of the present disclosure facilitate efficient testing of devices that is required as a part of grid interconnection certification, thereby resulting in saving time, and an easy and error-free certification process for the inverters to be connected to the public grids. This involves the repeated creation of test waveforms and capturing the output of the test script through communication with the measuring equipment. The embodiments also describe that the entire process is automated and it's possible to run different grid requirements in a very short span of timede, which results in the removal of different personnel running the test and introducing errors in the way the test data is interpreted.

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
inputting, by a central controller, a set of instructions to a device under test, the set of instructions corresponding to a firmware version to be tested by a variable alternating current (AC) source electrically coupled to the device under test;
transmitting, by the central controller, a command signal to an inverter redundant controller (IRC) of the device under test, the IRC configured to operate at least one direct current-to-alternating current (DC-AC) inverter, among a plurality of DC-AC inverters of the device under test, to attain a grid-tie state in response to receipt of the command signal;
upon operating the at least one DC-AC inverter in the grid-tie state, transmitting, by the central controller, a set of values corresponding to parameters of the variable AC source configured to simulate an AC grid, the set of values derived based at least on a grid interconnection standard, and wherein the set of values facilitates for generation of a set of test waveforms by the variable AC source;
accessing, by the central controller, test output data of the device under test from a measuring equipment, the test output data comprising information related to the response of the device under test corresponding to each test waveform of the set of test waveforms; and
generating, by the central controller, a test report based at least on the responses of the device under test to the set of test waveforms.

2. The computer-implemented method as claimed in claim 1, wherein generating the test report comprises:
extracting, by the central controller, one or more variables determining the responses of the device under test to each test waveform of the set of test waveforms from the test output data, the one or more variables comprising at least one of voltage, frequency, and time measurement; and
generating, by the central controller, the test report by analyzing the one or more variables determining the response of the device under test to each test waveform of the set of test waveforms.

3. The computer-implemented method as claimed in claim 2, further comprising:
monitoring, by the central controller, each test waveform of the set of test waveforms being simulated by the variable AC source to detect a change in magnitude of an electrical parameter of the test waveform at one or more time instances; and
facilitating, by the central controller, transmission of a pulse signal from the variable AC source to the measuring equipment based on detecting the change in magnitude of the electrical parameters at the one or more test instances, wherein the pulse signal facilitates the measuring equipment to mark the one or more time instances in the test output data.

4. The computer-implemented method as claimed in claim 3, further comprising:
determining, by the central controller, the response of the device under test at the one or more time instances based at least on a mark indicated for each of the one or more time instances in a test output data and the one or more variables at each mark.

5. The computer-implemented method as claimed in claim 1, wherein the command signal is transmitted to the IRC upon determining that the device under test is in an active mode, and wherein the grid-tie state is a state in which a DC-AC inverter of the device under test converts DC voltage from a DC source to an AC voltage.

6. The computer-implemented method as claimed in claim 1, further comprising:
monitoring, by the central controller, one or more parameters determining an operating condition of the variable AC source, the one or more parameters comprising a voltage, frequency, and phase of a test waveform generated by the variable AC source; and
operating, by the central controller, a switch that is electrically coupled between the device under test and the variable AC source in a closed state, when values of the one or more parameters are within a threshold value defined for each of the one or more parameters as per grid interconnection standards, wherein the switch operated in the closed state facilitates transmission of AC power generated by the plurality of DC-AC inverters to the variable AC source.

7. The computer-implemented method as claimed in claim 6, further comprising:
operating, by the central controller, the switch in an open state, when the values of the one or more parameters exceed the threshold value defined for each of the one or more parameters as per the grid interconnection standards, wherein the switch operated in the open state facilitates disconnection of the device under test from the variable AC source.

8. The computer-implemented method as claimed in claim 1, wherein the device under test is tested for at least one of under-voltage, over-voltage, under-frequency, over-frequency, and reverse or minimum import power test.

9. A system for testing a device under test comprising a plurality of direct current-to-alternating current (DC-AC) inverters and an inverter redundant controller (IRC), the system comprising:
a variable AC source electrically coupled to the device under test, the variable AC source configured to simulate an AC grid to test the device under test;
a measuring equipment coupled to the device under test and the variable AC source; and
a central controller communicably coupled to the device under test, the variable AC source, and the measuring equipment, the central controller configured to:
input a set of instructions to the device under test, wherein the set of instructions corresponds to a firmware version to be tested by the variable AC source;
transmit a command signal to the IRC of the device under test, wherein the IRC operates at least one DC-AC inverter, among the plurality of DC-AC inverters, to attain a grid-tie state in response to receipt of the command signal;
upon operation of the at least one DC-AC inverter in the grid-tie state, transmit a set of values corresponding to parameters of the variable AC source, wherein the set of values is derived based at least on the grid interconnection standards, and wherein the set of values facilitates for generation of a set of test waveforms by the variable AC source;
access test output data of the device under test from the measuring equipment, the test output data comprising information related to the response of the device under test corresponding to each test waveform of the set of test waveforms; and
generate a test report based at least on the responses of the device under test to the set of test waveforms.

10. The system as claimed in claim 9, wherein the variable AC source comprises one or more DC-AC inverters for simulating the AC grid based on the grid interconnection standards.

11. The system as claimed in claim 10, wherein the variable AC source is a four-quadrant AC source, and wherein the four-quadrant AC source is configured to operate instantaneously based on the set of values received from the central controller.

12. The system as claimed in claim 9, wherein the central controller is further configured, at least in part, to:
extract one or more variables determining the responses of the device under test to each test waveform of the set of test waveforms from the test output data, the one or more variables comprising at least one of voltage, frequency, and time measurement; and
generate the test report by analyzing the one or more variables determining the response of the device under test to each test waveform of the set of test waveforms.

13. The system as claimed in claim 12, wherein the central controller is further configured, at least in part, to:
facilitate a transmission of a pulse signal from the variable AC source to the measuring equipment based on detecting a change in magnitude of electrical parameters at one or more test instances, wherein the measuring equipment is configured to capture a mark each of the one or more test instances based on receipt of the pulse signal; and
determine the response of the device under test at the one or more test instances based at least on the marks indicated for each of the one or more test instances in the test output data and the one or more variables at each mark.

14. The system as claimed in claim 9, wherein the central controller transmits the command signal to the IRC upon determining that the device under test is operated in an active mode.

15. The system as claimed in claim 9, wherein the central controller is further configured, at least in part, to:
monitor one or more parameters determining an operating condition of the variable AC source, the one or more parameters comprising a voltage amplitude, frequency, and phase angle of the variable AC source; and
operate a switch between the device under test and the variable AC source in a closed state, if the one or more parameters determining the operating condition of the variable AC source are within a threshold value defined for each of the one or more parameters as per the grid interconnection standards, wherein the switch operated in the closed state facilitates transmission of AC power generated by the plurality of DC-AC inverters of the device under test to the variable AC source.

16. The system as claimed in claim 15, wherein the central controller is further configured to operate the switch in an open state, if the one or more parameters determining the operating condition of the variable AC source exceed the threshold value defined for each of the one or more parameters as per the grid interconnection standards, wherein the switch operated in the open state facilitates disconnection of the device under test from the variable AC source.

17. The system as claimed in claim 9, wherein the device under test is tested for at least one of under-voltage, over-voltage, under-frequency, over-frequency, and reverse or minimum import power test.

18. The system as claimed in claim 17, wherein the set of values corresponding to the parameters of the variable AC source is determined by the central controller based at least on the grid interconnection standards and a type of test.

19. The system as claimed in claim 9, wherein the variable AC source is configured to:
generate a pulse signal upon reception of the set of values from the central controller; and
send the pulse signal to the measuring equipment to mark one or more time instances in the test output data.

20. The system as claimed in claim 17, wherein a parameter under test (PUT) at the device under test includes one of voltage, frequency, power, and reactive power.
